(19) United States
(12) Patent Application Publication
(10) Pub. No.: US 2007/0108387 A1
(43) Pub. Date: May 17, 2007

(54) Tunable x-ray fluorescence imager for multi-element analysis

(75) Inventors: Wenbing Yun, Walnut Creek, CA (US); Yuxin Wang, Arlington Heights, IL (US); Michael Feser, Walnut Creek, CA (US); Srivatsan Seshadri, Walnut Creek, CA (US)

Correspondence Address: HOUSTON ELISEEVA, 4 MILITIA DRIVE, SUITE 4, LEXINGTON, MA, 02421, US

(73) Assignee: Xradia, Inc., Concord, CA (US)

(21) Appl. No.: 11/273,639

(22) Filed: Nov. 14, 2005

(51) Int. Cl. G01J 5/02

(52) U.S. Cl. 250/345

(57) ABSTRACT

A full-field x-ray fluorescence imager capable of recording high resolution maps of elemental concentrations with high signal to background in one image is described. Furthermore the methodology to have the same instrument record maps of different elements in series and how to register and overlay these maps properly is discussed.

### BACKGROUND OF THE INVENTION

X-ray fluorescence analysis leverages the characteristic that materials emit element-specific x-ray radiation, called fluorescence x-rays, when bombarded with higher energy excitation radiation, such as x-rays, electrons or, ions. These fluorescent x-rays from the sample can be analyzed using a spectrometer, which measures the intensity of emitted x-rays as a function of x-ray energy. It is therefore possible to determine the abundance of different elements and their relative concentrations within the excitation spot if the relative intensities are properly calibrated.

The spatial resolution of such analysis is generally limited by the size of the volume that is excited by the excitation radiation. Elemental maps are obtained by raster scanning the excitation probe over the sample and recording x-ray spectra in each point. This is a serial approach, in which an image is built up pixel by pixel using this point analysis.

In the past, some of the instant inventors have outlined systems that leveraged the chromatic characteristics of zone plates. The systems enable the spatial mapping of elements in high resolution images of the fluorescent x-rays on spatially resolving detectors such as charge coupled device (CCD) cameras. For example, U.S. Pat. Publ. No. US20030223536A1, entitled Element-Specific X-ray Fluorescence Microscope and Method of Operation, by Wenbing Yun and Kenneth W. Nill, and more recently U.S. patent application Ser. No. 11/177,227, by Wenbing Yun, et al., filed Jul. 8, 2005, entitled Back-end-of-line Metallization Inspection and Metrology Microscopy System and Method Using X-ray Fluorescence described imaging systems that can produce element-specific maps of samples, both of these applications being incorporated herein by this reference in their entirety.

Generally, zone plates are well characterized optical elements for focusing x-rays. High resolution x-ray microscopes using monochromatic x-ray radiation have been built employing zone plate lenses as the high-magnification objective optic. The spatial resolution of such instruments is often well below 50 nanometers (nm).

### SUMMARY OF THE INVENTION

In the present invention, the imaging property of zone plates is used to achieve spatially resolved elemental mappings, potentially at very high resolution. The highly chromatic nature of zone plate lenses is used to separate out fluorescence x-rays of different energies and therefore from different elements. To achieve this, preferably narrow-band excitation radiation is used. Energy selectivity and the reduction of background is further improved by the use of a suitable x-ray opaque central stop and a small excitation spot.

The inventive x-ray fluorescence imaging system is based on a zone plate lens that is capable of imaging the distribution and concentration of atomic elements in a sample preferably with very high spatial resolution. The imaging system is configured to image different elements by changing the focusing condition of the zone plate or by using multiple zone plates. The invention further concerns methods to ensure the proper overlay of maps or images of different elements.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic side plan view of an x ray imaging system according to the present invention;

FIGS. 2A and 2B ray are trace diagrams showing the zone plate optical train configured to image different wavelengths associated with different elements, for example, according to the present invention;

FIG. 3 is a schematic side plan view of another embodiment, lateral configuration, of an x ray imaging system according to the present invention;

FIG. 4 is a schematic side plan view of another embodiment, longitudinal configuration, of an x ray imaging system according to the present invention;

FIG. 5 is a flow diagram showing the process of collecting images at multiple wavelengths and forming a composite image according to the present invention;

FIG. 6 is a flow diagram showing the process of collecting images at multiple wavelengths using the lateral configuration embodiment and forming a composite image according to the present invention;

FIG. 7 is a flow diagram showing the process of collecting images at multiple wavelengths using the longitudinal configuration embodiment and forming a composite image according to the present invention; and

FIG. 8 is a ray trace diagram illustrating the relationship between the size of the excited region and the size of the central stop.

### DETAILED DESCRIPTION OF THE PREFERRED EMBODIMENTS

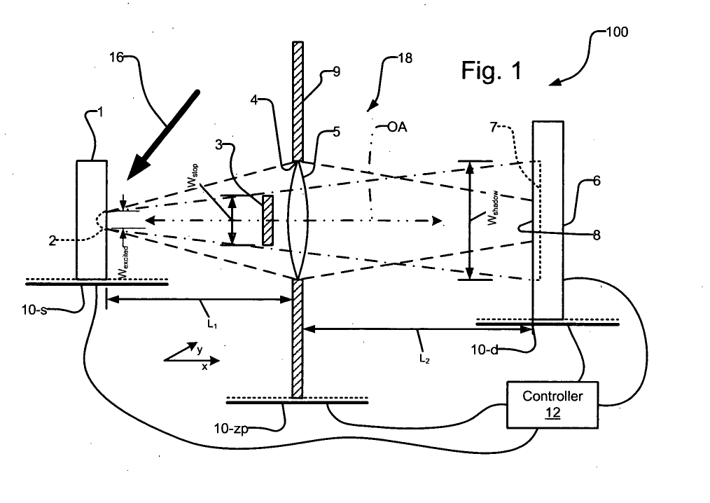

FIG. 1 illustrates a tunable x ray fluorescence imaging system 100 that has been constructed according to the principles of the present invention.

Specifically, a sample 1 is irradiated by an energetic excitation radiation beam such as a beam 16 comprising x rays, electrons, and/or ions. This creates an excited region 2 within the sample 1. This excited region 2 emits x ray fluorescence radiation.

The x rays from the excited region are handled by a zone plate optical train 18. This optical train includes a zone plate lens 5 that collects and focuses the x rays to form an image 8 on a detector 6. Preferably, the detector 6 is a spatially resolving system such as a system including a CCD having a two dimensional array of detection elements. Depending on the desired resolution, type of detector, and wavelength of the x rays, the x rays are either directly detected by the CCD or converted to an optical signal using a scintillator, for example, and then detected by the CCD or similar device. Additional optical elements, such as lens systems, are used in some cases between the scintillator and spatially resolving detector to provide further magnification prior to image detection. See U.S. patent application Ser. No. 10/704,382, filed: Nov. 7, 2003, entitled Scintillator Optical System and Method of Manufacture, by Wenbing Yun et al., which is incorporated herein in its entirety by this reference.

It is important that the excitation beam 16 precisely controls the size of the excited region 2 on the sample 1 for the formation of a background free region 7 on detection 8. Control of the excitation beam preferably is achieved by focusing mechanism such as a lens or mirror for example.

A central stop 3 is positioned along an optical axis OA of the zone plate optical train 18. The material and thickness of the central stop 3 are selected such that it is opaque or substantially opaque to x rays in the range of those emitted from the excited region 2. The central stop 3 is preferably located between the sample 1 and the zone plate 5, and as close to the zone plate 5 as possible. In a preferred embodiment, the central stop 3 is in contact with the zone plate 5 or fabricated directly on the zone plate or its supporting membrane.

The width or diameter W_{excited} of the excited region 2 is controlled to be the same but preferably smaller than the width or diameter W_{Stop} of the central stop 3 of the optical train 18. This configuration forms a region or shadow 7 having a width W_{shadow} on the detector 6 that is substantially free from x rays reaching the detector 6 directly from the excited region 2 through the zone plate 5. The shadow region 7 is important to remove or attenuate background radiation levels in the fluorescence image 8 that is formed on the detector 6 by the zone plate 5, because zone plates in general focus only a portion of the incident x-rays and allow often a larger a portion to pass through without being redirected.

Generally, the size of the excitation, for example electron, beam determines the size of the excitation spot 2 and is selected depending on the application. In other words, the larger the excitation spot 2, the wider is the field of view and vice versa and thus depends on how wide an area is to be imaged. However, there are advantages to using a small spot. For example, if the power loading is kept constant—that is, the applied voltage and the current of the electron or other beam is kept constant—then, reducing the area of the spot increases its brightness because of increased numbers of electrons within a smaller area. This increases the number of x-rays emerging from the sample per unit time, thereby increasing the signal, which shortens image acquisition times. Secondly, with a small excitation spot, the scattering of x-rays at the edges of the central stop 3 and the edges 4 of the aperture 9 (around the zone plate) is reduced. This improves the signal to background ratios in the image.

Typically, it is preferable to use a spot size no larger than half the size of the central stop 3. Larger sizes (up to just under the size of the beam stop) can be used if much higher background and consequently very poor signal to background ratios can be tolerated by the application.

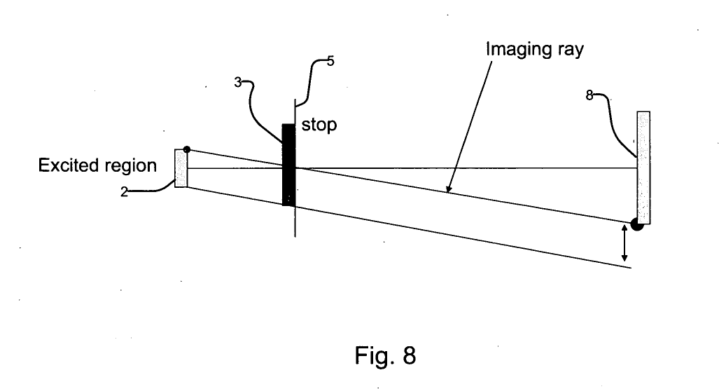

FIG. 8 illustrates the relationship between the size of the excited region 2 and the size of the central stop 3. The central stop 3 causes a shadow region on the detector that is free of any x-rays directly transmitted through the zone plate 5. Any directly transmitted x-rays would lead to an increased background intensity on the detector spoiling the fluorescence image 8. From the illustrated geometry, it becomes clear that the stop 3 has to be at least double the diameter of the diameter of the excited region 2 to have the full image of the excited region in the full shadow. Since the excited region 2 never has a very sharp definition of the diameter, but falls off as a function of distance from the region's center (e.g. a Gaussian distribution), the stop is chosen to be somewhat larger than double the diameter of the excited region in general. More specifically, here the spot is defined as the circle, or other shape, with equal intensity in each point containing 95% of the excitation.

Returning to FIG. 1, another restriction in the size of the spot 2 is that the diameter of the spot 2 should be less than the depth of focus. This way, the entire field of view is in focus. If the diameter of the spot is larger than the depth of focus than only some portion of the field of view will be in focus and the rest will appear defocused. So, typically, the spot sizes are limited to about half the size of the beam stop 3 or depth of focus, whichever is smaller. Values of spot sizes range from about 4 μm to 40 μm (assuming that the central stop 3 is 40 μm).

The distance L₁ between the excited region 2 and the zone plate 5 and the distance L₂ between the zone plate 5 and the detector 6 are controlled by a controller 12 such that x-rays of one particular energy form an in-focus image on the detector 6. The selected x-ray energy for which an in-focus image 8 is formed is chosen to match exactly the x-ray fluorescence energy for one particular element. In this case, the image 8 on the detector 6 represents the two dimensional projection of the spatial distribution of that element within the excited volume 2.

The ratio of L1 and L2 also determine the magnification in the zone plate optical train 18. Generally, the targeted magnification of the x-ray imaging system depends heavily on the kind of x-ray detector (more precisely its pixel size). Currently with a direct detection CCD, an x-ray magnification of 200-500 is employed. With different configurations such as a high-resolution detector, the magnification as low as 50 could be used. Thus, generally, the magnification is in the range of 50 to 500.

An additional aperture 4 of the zone plate optical train 18 is formed in plate 9 that is an opaque to x-rays. Generally, the plate 9 is made of high atomic number elements such at tungsten, platinum or gold and is ideally placed very close to the zone plate 5 along the optical axis OA. This aperture 4 is chosen to be only slightly larger than the diameter of the zone plate 5 to minimize background. The center of the aperture 4 is concentric with the center of the zone plate 5 to avoid blocking part of the zone plate 5 by the plate 9.

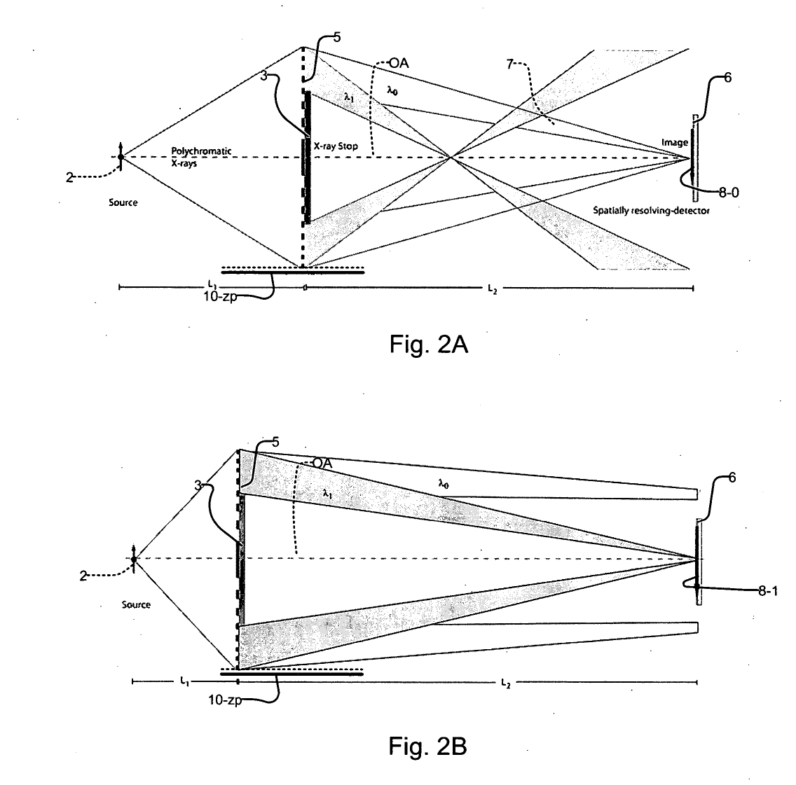

FIGS. 2A and 2B illustrate the x-ray energy selectivity for an excited region (source) that contains only two elements, which for simplicity are assumed to have only two x-ray fluorescence lines with wavelength λ₀ and λ₁ respectively. Other x-ray energies and x-rays not focused by the zone plate are not shown for clarity.

The zone plate 5 angularly separates the two wavelengths λ₀ and λ₁. If the distances L₁ and L₂ are chosen appropriately to fulfill the imaging equation or focusing condition for one wavelength λ₀ (FIG. 2A), an image 8-0 representing the distribution of the element fluorescing at this wavelength is formed on the detector 6. By changing the distances L₁ and L₂ to fulfill the imaging equation or focusing condition for the other wavelength λ₁, an image 8-1 representing the distribution of the other element is formed on the detector 6 as shown in FIG. 2B. It is important to note that in either case, the image formed on the detector 6 is purely due to one wavelength only and little or no background contribution from the other wavelength(s) is present.

It is recognized that to fulfill the imaging equation, in the latter referred to refocusing, either L₁, L₂ or both can be changed. It is recognized that the imaging magnification M defined as the ratio of L₂ to L₁ changes, unless the ratio is kept the same during refocusing, which would necessitate movement of two out of three optical components (excited region 2, zone plate 5, or detector 6) along the optical axis OA.

Referring back to FIG. 1, the preferred method of refocusing is to reposition the zone plate 5 along the optical axis OA, which changes both L₁ and L₂. In one embodiment, the zone plate 5 is carried by a precision x-axis, linear zone plate positioning stage 10-zp that moves the zone plate 5 along the optical axis OA under the control of the controller 12. In a highly magnifying geometry, L₂ is much larger than L₁ such that the relative change in L₁ is much greater than the relative change of L₂ thus changing the magnification of the image formed on the detector.

However, in other embodiments, precision x-axis stages are provided for the sample 1, stage 10-s, and for the detector 6, stage 10-d. These three stages 10-s, 10-zp, 10-d enable the positioning of the sample 1, zone plate 5, and detector 8 along the optical axis OA to thereby enable the reconfiguration of the optical train to create imaging conditions for multiple wavelengths while maintaining a constant magnification, for example, under the control of the controller 12.

It is also recognized that instead of moving one zone plate along the optical axis OA to refocus for separate wavelengths, multiple zone plates, each dedicated to a particular wavelength of interest are used in other embodiments.

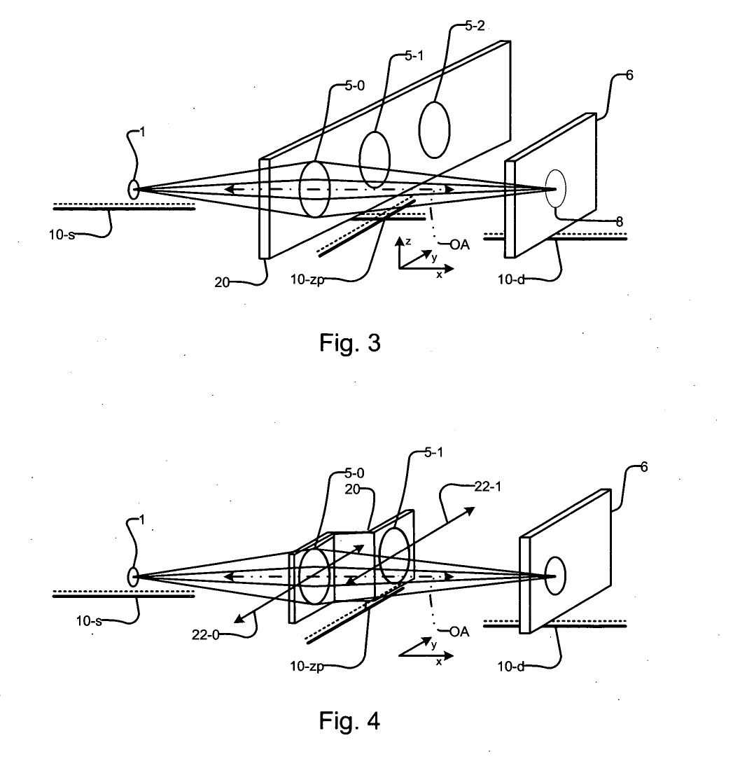

FIG. 3 shows a multiple zone plate embodiment. For the sake of simplicity, only three zone plates 5-0, 5-1, 5-2 are considered.

The parameters of the zone plates 5-0, 5-1, 5-2 are chosen such that the focal length of zone plate 5-0 for wavelength λ₀ equals the focal length of zone plate 5-1 for wavelength λ₁, and also equals the focal length of zone plate 5-2 for wavelength λ₂, in one implementation.

In this lateral configuration, the three zone plates 5-0, 5-1, 5-2 are confocal for different wavelengths λ and are placed one beside the other on a frame 20, which is carried on zone plate x-y axis positioner 10-zp. The zone plates 5-0, 5-1, 5-2 are located side by side in a plane perpendicular to the zone plate axis and optical axis OA, in one embodiment.

For example, considering only two wavelengths λ₀ and λ₁, zone plate 5-0 is used to image one wavelength λ₀ and zone plate 5-1 is used for imaging another wavelength with λ₁<λ₀. The zone plates are mounted on an x-y positioning mechanism (such as an x-y stage) 10-zp that allows either zone plate to be brought onto the center of the optical axis OA.

However, in another embodiment, the x-axis positions of the zone plates 5-0, 5-1, 5-2 are fixed with respect to the excited region of sample 1 along the optic axis. In this case, the stage 10-zp is only a y-axis stage to enable positioning along the y-axis only. It is then required that the zone plates 5-0, 5-1, 5-2 focus the wavelengths λ₀, λ₁, λ₂ respectively on the detector 6, the position of which is also fixed.

In such a setup, it is recognized that the distances L1 and L2 are fixed, which implies that the magnification M remains fixed. It is further recognized that the focal lengths of the zone plates are fixed and are equal to one another. Thus, for example, since λ₀>λ₁, the diameter of the first zone plate 5-0 is made larger than the second zone plate 5-1 in order to satisfy the condition that the focal lengths be the same and assuming that both zone plates have the same outermost zone width. It is recognized that in this case, the first zone plate 5-0 will have more zones than the second zone plate 5-1. It is also recognized that when one zone plate, say for example, zone plate 5-0 is aligned precisely to image wavelength λ₀, the second zone plate 5-1 and other zone plates, if any, are displaced from the optic axis and do not contribute to the image. An additional aperture slightly larger in diameter than the zone plates can be used to reject x-ray radiation to hit the zone plates not being used.

When the wavelength λ₁ is to be imaged, the frame 20 of the zone plates 5-0, 5-1, 5-2 is translated linearly in the direction perpendicular to the optic axis using stage 10-zp. This brings zone plate 5-1, for example, to the optic axis OA, which then is precisely aligned so as to focus the wavelength λ₁ on the detector 6. In this case, the zone plate 5-0 and 5-2 are moved out of the optic axis OA and are displaced perpendicular to it and no longer satisfy the imaging criterion. It is typically desirable, however, that stage 10-zp also provides for translation in the z-axis direction to compensate for positioning errors in that axis.

FIG. 4 shows a longitudinal configuration. Here, two zone plates 5-0, 5-1 are placed one behind the other to fulfill the imaging condition for different wavelengths λ no need or minimal need to refocus.

In the longitudinal configuration, two zone plates 5-0 and 5-1 are mounted one behind the other on frame 20 in the direction of the optical axis OA but displaced in the y-axis direction. It is recognized that the two zone plates 5-0, 5-1 might be identical in choice of parameters, but that this is not strictly necessary.

In the figure, the zone plate 5-0 is mounted on the imaging zone plate axis 5-0 that is closer to the excited region of sample 1, and the zone plate 5-1 is mounted on the non-imaging zone plate axis 22-1 that is farther away from the excited region of sample 1. It is recognized that the imaging and non-imaging zone plate axes 22-0, 22-1 are perpendicular to the optic axis OA. In this case, the distance between the two zone plates is determined in such a way so that the zone plates 5-0, 5-1 focus wavelengths °₀ and λ₁ on the detector 6. As before, the two zone plates are mounted on a precision y axis positioning system 10-zp. Although in other embodiments, an x-y axis, or x-y-z positioning stage is used.

In this geometry, the parameters of the two zone plates 5-0, 5-1 can be the same since the focal distances are different. Generally, the parameters that dictate focal length in a zone plate are diameter and zone width. It is recognized that the magnification changes as in the case where a single zone plate was used. As before, when one zone plate is aligned to image a particular wavelength, the second zone plate is displaced perpendicularly to the optic axis and no longer satisfies the imaging criterion. Again, as before, if wavelength λ₁ needs to be imaged, the second zone plate 5-1 is brought onto the optical axis OA and aligned precisely so as to focus the wavelength λ₁ on the detector 6. The first zone plate 5-0 is now displaced perpendicular the optic axis and no longer satisfies the imaging criterion.

An additional aperture slightly larger in diameter than the zone plates can be used to reject x-ray radiation to hit the zone plate not used. This prevents x-rays from being redirected onto the detector from the zone plate that is not in use.

It is recognized that in the foregoing discussion, only two or three zone plates were considered for simplicity. The designs, however, are valid when more than two or three zone plates are used. It is also recognized that if two or more zone plates are used they could be arranged either in the lateral configuration or longitudinal configuration or a combination of both depending on the number of wavelengths to be imaged and the allowable space.

It is recognized that the above-described embodiments are also valid for excited regions that contain more than two elements and elements that emit more than one x-ray fluorescence line, in which case one would select the most favorable x-ray fluorescence line depending on either the relative intensities, x-ray absorption and overlap with other x-ray lines or instrument design considerations.

For example, in some cases, certain lines may necessitate the zone plate to be positioned unrealistically close to the sample, and this could partially or wholly block the incident beam 16 on the sample 1 or cause collision with the surface of the sample 1 under certain geometries. In other cases, the zone plate may need to be positioned too far away, which may not be possible due to space limitations.

It is also recognized that x-rays are emitted from the excited region 2 that are not produced by x-ray fluorescence. One example is continuum x-rays produced by beams of electrons. Some of these x-rays can contribute to a background in the image on the detector, if not block by the aperture 4 or center stop 3.

For a meaningful multi-element analysis of the same region it is essential that the maps of single elements be registered precisely to each other to generate an overlay or measure of collocation of features and distances between features. If during refocusing the zone plate (or any other component) is moved off center from the optical axis OA, the apparent image center will shift on the detector 6. It is recognized that to avoid this, the mechanism moving the zone plate, stage 10-xp, and/or the sample, stage 10-s, detector, stage 10-d, have to be a precise linear motion systems aligned to the optical axis OA. To have the image center fixed during refocusing, it is necessary that the axial run out of the zone plate be within the targeted imaging resolution.

It is recognized that the severe restrictions imposed on the positioning mechanism can be loosened if necessary with the use of multiple zone plates. The reason is that large travel of the zone plate, which may be required when a single zone plate is used, is no longer required. In short, the use of multiple zone plates removes this necessity of large travel.

It is recognized that it is possible to calibrate the shift of the image center if the mechanism positioning the zone plate is reproducible. This is of importance if the movement axis for refocusing is not perfectly aligned to the optical axis or moves in a reproducible non-linear fashion.

It is furthermore recognized that for imaging known structures or elemental structures with common features such as IC patterns, cross-correlation algorithms can be used for the registration if the shift of the image center is not known.

Since images of different elements might have a different imaging magnification, a software scaling of images collected at different wavelength can be performed for proper overlay of elemental maps of different elements.

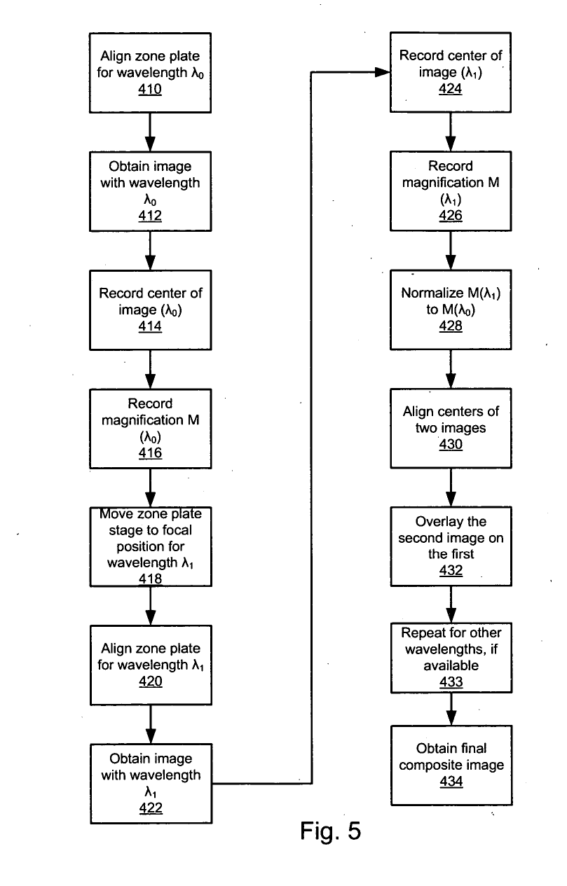

FIGS. 5-7 concern image acquisition and registration steps to form a composite image showing the distribution of multiple elements in the excited region 2.

FIG. 5 illustrates the process of creating a composite image showing the mapping or the distribution of multiple elements from sample 1 using the embodiment of FIG. 1.

Specifically, in step 410, the zone plate 5 is aligned for a wavelength λ₀. Specifically, the lengths L₁ and L₂ are controlled using the positioning stages 10-s, for the sample, 10-zp for the zone plate 5, and/or 10-d for the detector 6 under the control of the controller 12.

Then, in step 412, an image is obtained for the wavelength λ₀. In the illustrated embodiment, this image is downloaded from the detector 6 into the controller 12. The controller 12 then stores the image and analyzes the image from the detector to determine and record a center of the image for wavelength λ₀ in step 414. It also records the magnification M for λ₀ in step 416.

The magnification is a function of the ratio of L₂ over L₁. The controller 12 obtains this the magnification information from the precision stages 10-S, 10-zp, and/or 10-d.

The stages 10-s, 10-zp and/or 10-d are then adjusted under the control of the controller 12 to move the relative positions of the sample 1, zone plate 5, and detector 6 so that an imaging condition is created for wavelength λ₁ in step 418. The zone plate 5 is aligned for λ₁ in step 420 relative to the optical axis OA.

A second image for wavelength λ₁ is obtained in step 422. This image is downloaded from the detector 6 into the controller 12. The controller 12 then processes this image in step 424 to determine a center of the image for λ₁ and also record a magnification for λ₁ based on the new values for L₁ and L₂.

In step 428, the images are scaled relative to each other by reference to the recorded magnifications. In effect, one of the images is expanded or contracted using conventional imaging processing techniques so that they each have effectively the same magnification. In step 430, the centers of the two images are aligned. Finally, the images are overlaid on top of each other in step 432. The process can be repeated for still further wavelength in step 433, until a final image in obtained in step 434.

Often, and in the preferred embodiment, the images associated with the different wavelengths λ₀, λ₁ are given different colors. This creates a false color image in which the colors correspond to the different wavelengths and also thus the different elements in the sample 1 that generated each of the wavelengths.

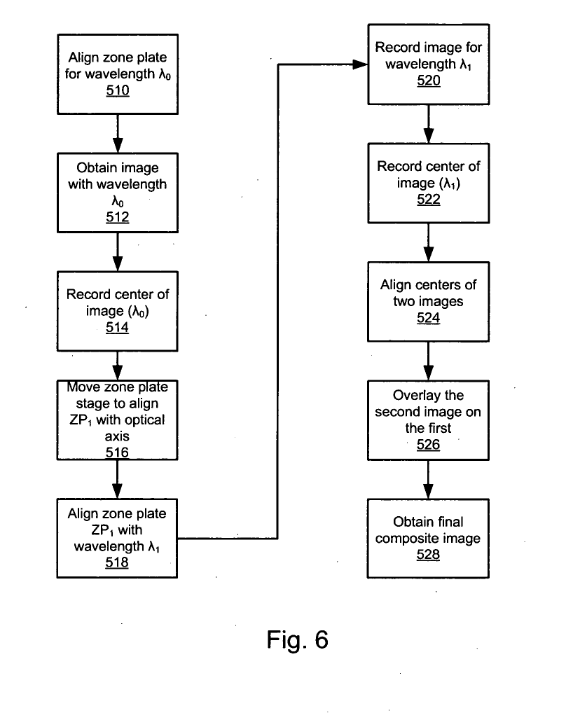

FIG. 6 is a flow diagram illustrating the method for forming a composite image using the lateral configuration illustrated in FIG. 3.

In this implementation, compensation for different magnifications is not required since the zone plates are selected such that the magnification is held constant between the different images.

In more detail, in step 510, the first zone plate 5-0 for wavelength λ₀ is positioned to thereby obtain an image for wavelength λ₀ in step 512 on the detector 6.

The center of this image is determined by the controller 12, after the image is downloaded from the detector 6 into the controller 12. The zone plate stage 10-zp is then controlled by the controller 12 to move the second zone plate 5-1 to be coincident with the optical axis OA in step 516. The alignment of the second zone plate 5-1 is then made with respect to wavelength λ₁ in step 518 and the image is recorded for λ₁, in step 520. In step 522, the center of the second image, for wavelength λ₁, is determined and recorded in step 522. Then the two centers of the images are aligned relative to each other by the controller 12 in step 524. The images are then overlaid in step 526 to obtain a final composite image in 528.

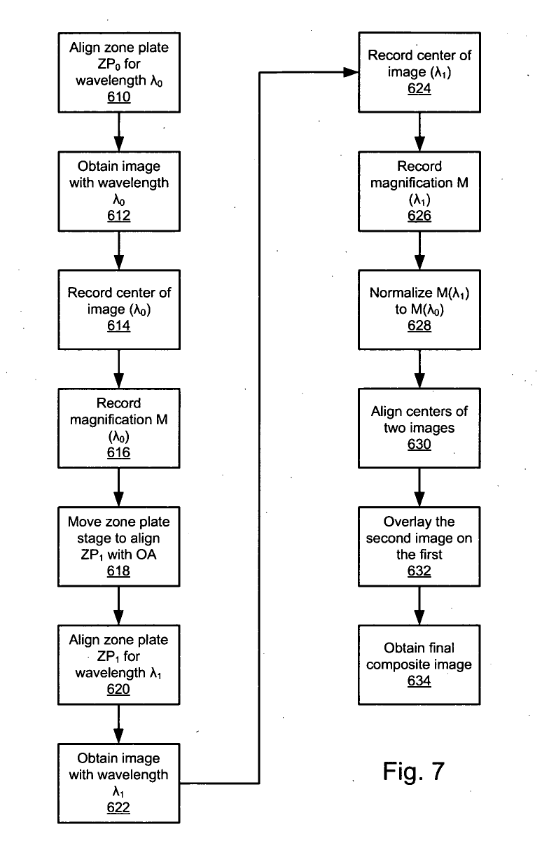

FIG. 7 is a flow diagram illustrating the process for generating the composite image in the longitudinal configuration as illustrated in FIG. 4. In this embodiment, since the magnifications may be different between the two images, magnification correction is again required as discussed in FIG. 5 previously.

In more detail, in step 610, the first zone plate 5-0 is aligned for wavelength λ₀, then an image is obtained at wavelength λ₀ by the formation of the image by the zone plate 5-0 on the detector 6, in step 612. The center and magnification of this first image, for λ₀, after being downloaded from the detector 6 into the controller 12, is then recorded in the controller 12 in steps 614 and 616. The zone plate stage 10-zp is then adjusted to align the second zone plate 5-1 with the optical axis OA in step 618. The second zone plate 5-1 is then aligned for wavelength λ₁ in step 620. An image is obtained in step 622 for the second wavelength λ₁.

In step 624, the center of the second image, for λ₁, is recorded in step 624 by downloading the image from the detector 6 into the controller 12. The magnification for this second image for λ₁ is then recorded in step 626. This is determined by comparing the ratios of L₁ to L₂ or analysis of the image. Two images are then scaled to have effectively the same magnification. In effect, one of the images is expanded or shrunk so that the effective pixel to pixel distance on the sample is the same for both of the images. The centers of the images are aligned in step 630 and the images are overlaid on top of each other in step 632. This yields the final composite image in step 624.

While this invention has been particularly shown and described with references to preferred embodiments thereof, it will be understood by those skilled in the art that various changes in form and details may be made therein without departing from the scope of the invention encompassed by the appended claims.

What is claimed is:

1. An x-ray fluorescence imaging system comprising:
a spatially resolving detector for detecting fluorescence x ray radiation;
a zone plate optical train for imaging multiple wavelengths of the fluorescence x ray radiation from an excited region of a sample onto the detector; and
a controller for receiving images from the detector for the multiple wavelengths and combining the images into a composite image.

2. A system as claimed in claim 1, further comprising an x-ray opaque central obscuration in the zone plate optical train for blocking x ray radiation from the excited region from directly reaching the detector.

3. A system as claimed in claim 2, wherein a size of the excited region is smaller in diameter than the central obscuration to generate a reduced background region on the detector.

4. A system as claimed in claim 1, wherein the excited region is created by directing an electron beam on the sample.

5. A system as claimed in claim 1, wherein the excited region is created by directing an x ray beam on the sample.

6. A system as claimed in claim 1, wherein the excited region is created by directing an ion beam on the sample.

7. A system as claimed in claim 1, further comprising at least one stage for adjusting a distance between the sample, zone plate of the zone plate optical train, and the detector to create focusing conditions for the multiple wavelengths.

8. A system as claimed in claim 7, wherein the focusing conditions are created by moving the zone plate of the zone plate optical train relative to the sample and detector.

9. A system as claimed in claim 7, wherein the focusing condition is creating by moving two of the zone plate of the zone plate optical train, the sample, and the detector.

10. A system as claimed in claim 1, wherein zone plate optical train provides the same magnification for the images at the multiple wavelengths.

11. A system as claimed in claim 1, wherein the optical train comprises two or more zone plates that are alternately moved into an optical axis to form the images at the multiple wavelengths.

12. A system as claimed in claim 11, wherein the zone plates are designed for different x-ray fluorescence wavelengths and the zone plates are located in the same plane perpendicular to the optical axis.

13. A system as claimed in claim 11, wherein the zone plates are located at different distances away from the sample to satisfy the focusing condition for the multiple wavelengths.

14. A system as claimed in claim 1, wherein the controller corrects for displacement in the images at the multiple wavelengths after image acquisition.

15. A system as claimed in claim 1, wherein the controller corrects for changes in magnification in the images at the multiple wavelengths after image acquisition.

16. An x-ray fluorescence imaging method, comprising:
imaging multiple wavelengths of the fluorescence x ray radiation from an excited region of a sample onto a detector; and combining the images into a composite image.

17. A method as claimed in claim 16, further comprising blocking x ray radiation from the excited region from directly reaching the detector.

18. A method as claimed in claim 17, wherein a size of the excited region is smaller in diameter than a central obscuration blocking the x ray radiation to generate a reduced background region on the detector.

19. A method as claimed in claim 16, further comprising generating the excited region by directing an electron beam on the sample.

20. A method as claimed in claim 16, further comprising generating the excited region by directing an x ray beam on the sample.

21. A method as claimed in claim 16, further comprising generating the excited region by directing an ion beam on the sample.

22. A method as claimed in claim 16, further comprising adjusting a distance between the sample, zone plate of a zone plate optical train, and the detector to create focusing conditions for the multiple wavelengths.

23. A method as claimed in claim 22, wherein the focusing conditions are created by moving the zone plate of the zone plate optical train relative to the sample and detector.

24. A method as claimed in claim 22, wherein the focusing condition is creating by moving two of the zone plate of the zone plate optical train, the sample, and the detector.

25. A method as claimed in claim 16, further comprising providing the same magnification for the images at the multiple wavelengths.

26. A method as claimed in claim 16, further comprising providing two or more zone plates that are alternately moved into an optical axis to form the images at the multiple wavelengths.

27. A method as claimed in claim 16, further comprising correcting for displacement in the images at the multiple wavelengths after image acquisition.

28. A method as claimed in claim 16, further comprising correcting for changes in magnification in the images at the multiple wavelengths after image acquisition.
